(19) United States
(12) Patent Application Publication
(10) Pub. No.: US 2003/0217108 A1
(43) Pub. Date: Nov. 20, 2003

(54) Method and apparatus for providing an interactive messaging session for electronic mail users

(76) Inventor: Mariam Karim, San Jose, CA (US)

Correspondence Address: MARIAM A. KARIM, 2161 HILLSTONE DRIVE, SAN JOSE, CA, 95138, US

(21) Appl. No.: 10/150,200

(22) Filed: May 17, 2002

(51) Int. Cl. G06F 15/16

(52) U.S. Cl. 709/206; 709/207

(57) ABSTRACT

This method will allow electronic mail users to engage in an interactive dialog session without needing any other information that is required by proprietary interactive communication mechanisms, like proprietary user identifications or proprietary protocols not generally available to users who do not belong or subscribe to a particular user or technology community. The electronic mail is utilized as the “boot-strap” to locate, route, notify and the handshaking mechanism to negotiate and exchange the mutual data required to engage in a separate and distinct form of interactive communication.

This mechanism allows users to instantaneously switch to an interactive session from a non-interactive e-mail session, as long the users can be reach each other (or others) by e-mail, they can also engage in the interactive dialog initiated by the e-mail session but transferred to a separate connection once the interactive session is engaged.

### BACKGROUND OF THE INVENTION

1. Field of the Invention

The present invention relates generally to data processing systems, and more particularly to methods, systems, and products for facilitating electronic communication between computer users.

2. Description of Related Art

Computer users can communicate with each other using electronic mail in the communication network. Each user participating in the electronic mail activity needs to register a unique user name within a particular computer network domain. The initiating user will address another user with the unique user-name with the particular domain address and attach the message to this electronic collection of data. The “SEND” action from the Electronic-Mail client on the senders computer will route the message to the intended recipient via the computer communication network.

A Computer server system with an electronic message routing and processing mechanism on the side of the sender of the electronic mail will route the message to other routing/processing servers and finally deposit the message at the electronic-mail routing/processing server in the same domain of the recipient. When the recipient initiates a client electronic mail program on his/her computer, this program will collect all incoming electronic mail messages residing on the Electronic Mail Routing/Processing (E-mail Server). The recipient may read, delete or respond to the message, which will be routed to the initiater of the electronic message.

In addition to the asynchronous electronic mail system (where the recipient does not need to acknowledge or respond to a message sent to him or her), Instant Messaging is gaining popularity among computer users in the electronic communication networks.

In this type of message communication system (popularly known as Instant Messaging), the initiator of the electronic message communication will need to identify the user from a list (sometime known as a “buddy-list”) and send the message. The message will be routed just like the Electronic Mail message until the recipient is identified and located within a central processing program (An instant Messaging server).

The recipient needs to be logged onto a computer to continue this communication activity. The user program is notified, and the recipient may acknowledge the sender's message and respond back instantly.

While Electronic Mail (from now on, being referred to as “e-mail”), the identifying addresses for the participants are widely known, shared and concocted in a way where they can be located and traced relatively easily, Identifying Instant-Messaging Names are generally known and identified among a particular community of users, who know what the Instant Messaging nickname stands for.

An example of a particular identifying e-mail address can be “John.Doe@CalgaryUniversity.edu” or “George.Washington@US-Presidents.gov”. John Doe belongs to Calgary University (an educational institution noted by the .edu extension of the address), George Washington belongs to a fictitious United States Government entity denoted by the .gov extension. Another example may be “John.Smith@PrivateCompany.com”, where John Smith is associated with a commercial entity denoted by the .com extension of the address.

Although not all e-mail addresses are as clearly denoted and may not be concocted to follow the same pattern, e-mail addresses are generally shared more widely than Instant Messaging Nicknames.

Examples of Instant Messaging user-names can be “Johnny 12345”, “NewKid”, which may only be identifiable as to the true identity by particular users who belong to the specific community of the user.

Instant Messaging identifier addresses are not traceable by members who are not part of the immediate community (these Instant Messaging users cannot be “spammed” or be sent unsolicited bulk mail).

Although there are two major Electronic Mail Message communication protocol processing (format order and content methodology) format used, which are commonly known as IMAP and POP, the basic messaging protocol still follows a single industry data communication format known as SMTP (Simple Mail Transfer Protocol) This allows all electronic mail users to communicate with each other regardless of the E-mail client type, computer platform type or the E-mail Message Server processing systems.

There are several leading Instant Messaging Protocols in the industry, and each of them follow a proprietary messaging data protocol which does not allow members from different Instant Messengers to communicate with each other across the different Instant Messaging applications. Although there is a growing demand for Instant Messaging to facilitate quick and acknowledged messaging in personal and business environments, the limitation of not having access to a generalized universal addressing scheme and communication translation mismatch between various different type of Instant Messaging services, applications keeps the powerful Instant Messaging activity within small boundaries of user communities.

A mechanism to initiate Instant Messaging from the the Electronic Mail system and mapping communication network identities of the Electronic mail Addresses of the participants of the electronic mail to a system of Instant Messaging, will make the facilities of Instant Messaging available to a broader set of users.

If communication network users could “Instant Message” with anyone who has an Electronic Mail identity or address, then the Instant Messaging facility gets opened up to all such users, not just members of particular pockets of user communities who subscribe to any of the Instant messaging systems with proprietary message transfer and format protocols, and proprietary user address list. Users would not have to figure out the nicknames of users as long as they have the e-mail addresses of who they would like to communicate with.

### SUMMARY OF THE INVENTION

From this point of the document on, the application which is the implementation of the theoretical principles of this invention will be called “Insta-chat” for consistent identification of the component.

The overall description of the invention can be highlighted by the following description:

Members of the computer communication networking environment can utilize Electronic Mail as the initiator of direct, interactive dialog with each other. E-mail serves as the method of identifying, initial location finding, routing and notifying mechanism to start a completely separate and distinct, interactive communication session which is similar to a telephone dialog, except it is in written form. There may be implementations of the dialog that use voice too, which would also be within the scope of this invention and therefore protected by this patent request.

One example of an implementation would be that the initiator of this communication session, who is a computer user within the networked environment has the Inter-Chat client application installed on his computer, along with the Electronic E-mail client system. The MailSpeak communication system can be initiated either via the MailSpeak application or the E-mail application. E-mail applications may add a button on the e-mail application to initiate a MailSpeak Session, similar to “placing a telephone call” to a desired E-mail address. The initiation of the MailSpeak mechanism or a mechanism similar thereof is also within the scope of this invention. Either through the MailSpeak Client Application or the E-mail application, the sender sends a MailSpeak request to another Computer User who is on the network and has a valid E-mail address that is reachable by the sender.

The E-mail Notification has a special header which identifies clearly that this is an MailSpeak Communication Initiator, similar to a “Phone Ringing”. The Subject header, which is initially visible to the recipient once he or she has collected this new e-mail from the E-mail server (or the electronic e-mail post-office) may note as an example:

“MailSpeak: PHONE-CALL-From: John Doe@wherever.com—SELECT TO ANSWER”

The MailSpeak Application on the Sender's side will also attach an encrypted and secured MailSpeak Identification Protocol File witth the e-mail. This small file will have the connection information of the sender. The information will include the routing and location information of the sender, along with the connection mechanism that the sender is requesting or prefers.

The MailSpeak client application or method for the computer users to communicate with each other after the e-mail leveraged identification and handshaking has been completed can be implemented various different ways.

Th MailSpeak can be a standalone native client application implemented with Common programming languages like C, C++, Java (and all such computer languages).

The MailSpeak can be an integrated component of the Electronic Mail client. The MailSpeak application may be packaged as a library component which can be integrated by other electronic mail vendors to include the MailSpeak functionalities into their Electronic Mail client.

The MailSpeak functionality can be integrated within a standalone web browser, or a web-service can be implemented that works with or without the browser (therefore the internet connecting and rendering technology being built into the MailSpeak client).

All such implementations are embodiment of the principles within the scope of this invention and therefore protected by this patent request.

Some of the connection mechanisms the users may choose for various reasons could be:

Direct connection without any intermediary servers, for example Peer-2-Peer connections. Peer-2-Peer computer communication technology refers to communication between two networked computers and the computer programs within them directly without any other managing or processing server in the middle. There maybe other computers that may route the connection to be able to reach the two computers, but no specific central program is needed to manage the connection mechanisms of the two programs.

Address of Intermediary Secure Servers, Authentication Servers to route the dialog in a secure manner

Routing information to an MailSpeak User and Data Management Server

An internet URL (Universal Resource Locator) where both the users can publish their dialogues interactively and in real-time dynamically so the communication can still take place in spite of firewalls and other connection hurdles between the users.

Once the recipient selects the initiating e-mail, double-clicking or selecting the MailSpeak file attachment will automatically invoke a resident MailSpeak Client on the recipient user's computer.

If the recipient is a new user and does not have an MailSpeak application installed, the MailSpeak file that came attached with the sender's initiating email will instruct the new user of a networked location where the application can be downloaded quickly and installed to respond to the MailSpeak request. The MailSpeak application can be at another accessible website or installed centrally within the recipient's organization for user access.

If the recipient does not have the MailSpeak installed, and proceeds to do so, the sender at that time will be notified with an automatic “Return Response” from his/her original e-mail which will tell the sender that the recipient is in the process of getting back to him.

Once the MailSpeak application is up and running, the application will read the attached MailSpeak properties file that came attached with the sender's e-mail and proceed to connect with the instructed mechanisms to the noted sender's location or address.

The MailSpeak application has two dynamic sections (sections that are changing). The top section can be what the sender wrote as the initiating message. The bottom section can be what the recipient will type to respond and participate in the interactive dialogue.

Other static sections of the MailSpeak application will be the sender's address, routing information and the following facilties: p1 Choice to save the session in a file locally or at the subscribing MailSpeak servers

Choices to set connection mechanisms and server/routing data for all connections

Voice or video transmission options in additionj to written dialog

Ability to show or view a sketch or picture files.

In addition to the MailSpeak Client Application designed for users to communicate with each other, this invention also requests the inclusion of the MailSpeak Server. The purpose of the Server will be to manage and act as a intermediary computer program which will do the following if necessary:

Act as a Security interface between external and internal users to keep out unwanted or destructive data for the internal network.

For Enterprise installations, manage and route high numbers of users and activities by providing additional computer and network resources. This intermediary program will balance the load of the activity and route the communication activities appropriately to facilitate a smooth MailSpeak communication session between the users.

If other types of Messaging, Chatting, interactive communication clients are used in the organization which will not map to e-mail, the MailSpeak Router may transfer control over to the other proprietary Instant Messaging clients. The mapping of these wouldn't have been possible if it wasn't for the initial e-mail message. So the purpose of the MailSpeak server in this case would be to map the e-mail address of senders and recipients to appropriate proprietary nicknames for the desired or adopted Instant messaging clients for the organization. The uniqueness of this invention is that the MailSpeak system of the Server will map to the proprietary identity of a user within the proprietary messaging system to the well-known e-mail identity of the user. This of course is configureable, and the user may wish to block this mapping to the proprietary identity from users outside of the environment who may wish to contact him via the messaging utility.

The MailSpeak Server may be able to be configured to have two users communicate with each other even if they are both using different Instant Messaging Protocols. Protocol Translation and User Name Mapping adapters can be written and plugged into the MailSpeak server to facilitate this communication between Instant Message users using different Instant Messaging protocols.

MailSpeak server may host webservers dedicated to hosting two-way HTTP (HyperText Transfer Protocol), HTML (HyperText Markup Language) based communication sessions. The communication is based on two users interacting to the same webpage, the interactions are visible to both of them.

The MailSPeak server will also facilitate more than two users to communicate interactively with each other in a conference-call mode.

Additional names for the communication methodology described in this patent which are initiated and/or leveraged by the electronic mail system are also noted as: MailSpeak, MailChat, MailRap, InterWrite.

### BRIEF DESCRIPTION OF THE DRAWINGS

The accompanying drawings, which are incorporated and constitute a part of the specification, illustrate an implementation of the invention and, together with the description, explains the uniqueness and the advantages along with the theoretical principles of the invention.

FIG. 1 is a block diagram which shows the interactions of two computer users initiating the MailSpeak communication with standard Internet, Network Electronic Mail, and then transferring the control to the MailSpeak application once the users have managed to locate each other and complete a successful network handshaking process. The FIG. 1 drawing shows how users on the network can engage in an interactive dialogue as long as they are reachable to each other via an e-mail systems. The MailSpeak technology uses the E-mail system to identify and route the users to each other.

FIG. 2 is a process flow diagram which shows the embodiment of the implementation from start to the ultimate successful communication between two users using MailSpeak.

FIGS. 3 is a continuation from FIG. 1 Process Flow diagram.

### DETAILED DESCRIPTION

This section will make reference to the attached diagrams and present the information in detail to illustrate an implementation of the MailSpeak Instant Wide Communication System which is the core principle of this invention.

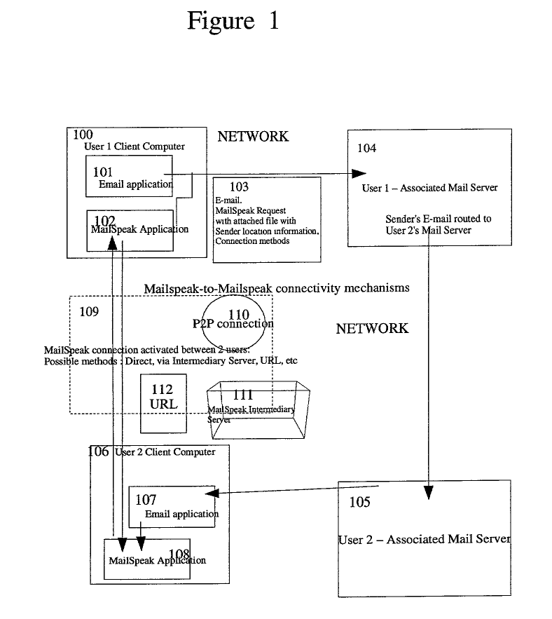

FIG. 1 shows a Block Diagram consisting of a Client Computer system with User 100 or the Sender, the associated Mail Server (Block 103)which has the user registered and is capable of locating the intended recipient and route the mail packet accordingly to the recipient address specified by the sender.

In Block 100, the Sender utilizes either the E-Mail application (101) or the MailSpeak application (102) to initiate the MailSpeak communication. The integrated E-Mail application will attach the appropriate MailSpeak configuration data to the e-mail. This configuration data, in essence is the “Return address” in MailSpeak format. Which means, it specifies the connection and routing mechanism the recipient's MailSpeak application (Block 108) can use to connect back to the MailSpeak application on the Sending User's computers.

Once the initiating mail has reached the recipient's E-mail server (Block 105), if the recipient is logged on the his computer (Block 106) and connected to the network, the e-mail client application on the recipient's computer (Block 107) will show a new MailSpeak message header in his INBOX of the e-mail application(Block 107).

If the recipient user selects this message, the attached configuration file will launch the MailSpeak client application (Block 108) if it is installed on the system. Standard e-mail systems will allow associating specific attachment file-types to launch associated applications when selected. This would be the similar mechanism, the user needs to set the email up to associate the MailSpeak type file to be associated to the MailSPeak Application.

The MailSpeak involvement or the transfer of control from the email to the MailSpeak messaging can be implemented in several ways, the key invention here is that the initiating user was able to locate and notify the desired recipient user on the network utilizing any electronic mail application, and then transfer the communication to the interactive mailSpeak application.

Another example of this transfer of protocol control can be:

The MailSpeak client application is already up and running on the client computer; this application is checking incoming mail on the mail server. If it locates a MailSpeak e-mail message, it will ring an audible alert to notify the user that someone is trying to contact him/her via e-mail and subsequently the interactive MailSpeak. The recipient can decide to answer this call directly on the MailSpeak utility and engage in the interactive dialog.

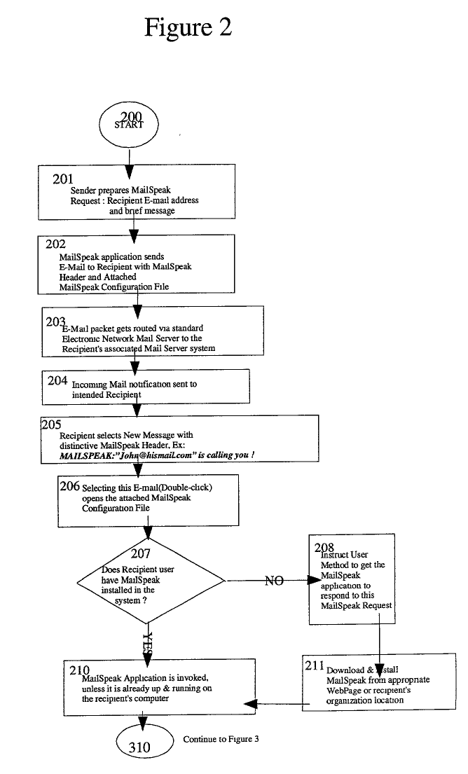

FIG. 2 is a process flow diagram for an embodiment of a method initiated at the Client computer 100. The sequence of operations starting at 200 is an illustration of a starting point for this mechanism, but is not limited to this specific type of a starting point. Events can be initiated by any plurality of users at various points in time by various types of applications. For this particular diagram, it is a single user initiating the communication process for MailSpeak. The sender wants to communicate to another user on the network ultimately in an interactive manner rather than the electronic mail. The sending user does not know the recipient user's proprietary Instant Messaging identities or nicknames, either of these users may not participate in the “like” Instant Messaging community. MailSpeak will break this limitation by initiating a notification and then to the MailSpeak interactive dialogue.

The MailSpeak initiating e-mail in Block 202 can be composed from a MailSpeak client or future e-mail clients can integrate the operation within their e-mail application so the sender may simply just click a button (for example, with a picture of a telephone) to send a MailSpeak initiating e-mail which is differentiated by other types of e-mail by a SUBJECT Header identifying this packet of mail as a MailSpeak initiator mail, and an encrypted file attachment which consists of the connection mechanism the sender wishes the recipient's MailSpeak application should use to start the interactive dialogue.

Block 203 through 205 indicates that this MailSpeak initiating e-mail gets routed like any other e-mail to the recipient's client computer and if the user is available, in essence, to pick up the call, he/she may select the message. The selection of the message and double-clicking on the attached MailSpeak file will launch the MailSpeak Interactive Dialogue application (Block 206).

In 207, if the MailSpeak application is not found in the client user's computer, which maybe a common occurrence because while the MailSpeak application is still new in the market, not all users may have the MailSpeak client. But this mechanism still will not limit users on the network from communicating with anyone with e-mail and on the internet.

If the recipient user wants to participate in the interactive conversation via MailSpeak, the system will allow him to download the MailSpeak application from an indicated point in the network or the web (which maybe noted in the attached configuration file) as noted in block 208 and 211.

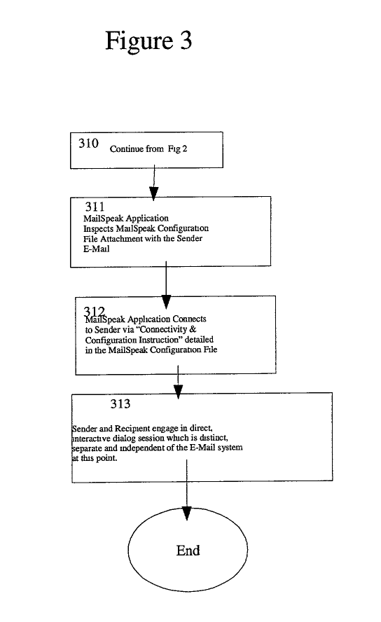

Block 210 shows the MailSpeak client application taking over and preparing to communicate with the initiating sender of the e-mail. FIG. 3 is a continuation of this process flow from FIG. 2 (Block 310). The MailSpeak application inspects the attached configuration file (311) and connects to the sending user's awaiting MailSpeak client (Block 312).

The MailSpeak client is programmed to be able to try various different connection mechanisms to locate the sending user's MailSpeak application. The various methods can be direct Peer-2-Peer connection, via a proxy servers, socks servers, a common webpage setup for secure MailSpeak dialogues, via MailSpeak servers at either or both end of the user's environments, just like the Mail servers who are facilitating the mail traffic.

Block 313 shows that the communication between the two (or more) users are taking place not via e-mail anymore, but an interactive dialog session using MailSpeak.

What is claimed is:

1) A method in a data processing system for using Electronic mail to locate, route, notify other users to engage in an interactive dialog session in an automated manner. Using the widely used electronic mail system to initiate a separate and distinct connection with a different protocol will allow users with standard e-mail to switch to an interactive communication mode instantaneously without dealing with proprietary protocols and identities which are standard for other forms of interactive communication. Any user with a standard e-mail address can communicate with another user with e-mail facilities in an interactive conversation manner. The system utilizes e-mail to identify, route, notify, and execute the handshaking mechanism to exchange the subsequent interactive dialog connection configuration information between the users.
